(19) United States
(12) Patent Application Publication
(10) Pub. No.: US 2010/0313971 A1
(43) Pub. Date: Dec. 16, 2010

(54) REGULATOR WITH HIGH FLOW RATE STABILITY

(76) Inventors: J. Reese Moore, New Braunfels, TX (US); Robert Clifton Jones, JR., Stillwater, OK (US); Brian Keith Yutzy, New Braunfels, TX (US); Thomas V. Lozito, (US); Charles M. Olds, Martindale, TX (US); Angelica Wright, El Paso, TX (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/752,441

(22) Filed: Apr. 1, 2010

Related U.S. Application Data
(60) Provisional application No. 61/166,096, filed on Apr. 2, 2009.

(51) Int. Cl. F16K 31/36; F16K 31/12

(52) U.S. Cl. 137/510; 137/15.19

(57) ABSTRACT

A pressure regulator comprising a housing having an inlet port and an outlet port, a linearly sliding member for selectively covering a section of a passage between the inlet port and the outlet port, a diaphragm interconnected to the linearly sliding member to slide the linearly sliding member in reaction to pressure levels in the housing, and a valve seat located in the passage between the inlet port and the outlet port. The linearly sliding member includes a sealing disc for preventing fluid flow past the valve seat. The valve seat is located closer to the outlet port than to the inlet port.

### CROSS-REFERENCE TO RELATED APPLICATION

This application claims priority to U.S. Provisional Application No. 61/166,096 filed on Apr. 2, 2009 and entitled REGULATOR WITH HIGH FLOW RATE STABILITY.

### FIELD OF THE INVENTION

This invention is applicable to a wide range of gas pressure-regulating applications, but is designed for particularly advantageous use in propane recreational vehicle appliance applications.

### SUMMARY OF THE PRESENT INVENTION

An aspect of the present invention is to provide a pressure regulator comprising a housing having an inlet port and an outlet port, a linearly sliding member for selectively covering a section of a passage between the inlet port and the outlet port, a diaphragm interconnected to the linearly sliding member to slide the linearly sliding member in reaction to pressure levels in the housing, and a valve seat located in the passage between the inlet port and the outlet port. The linearly sliding member includes a sealing disc for preventing fluid flow past the valve seat. The valve seat is located closer to the outlet port than to the inlet port.

Another aspect of the present invention is to provide a method of assembling a pressure regulator comprising providing a housing having an inlet port and an outlet port, positioning a linearly sliding member in the housing for selectively covering a section of a passage between the inlet port and the outlet port, interconnecting a diaphragm to the linearly sliding member to slide the linearly sliding member in reaction to pressure levels in the housing, locating a valve seat in the passage between the inlet port and the outlet port, providing the linearly sliding member with a sealing disc for preventing fluid flow past the valve seat, and locating the valve seat closer to the outlet port than to the inlet port.

Yet another aspect of the present invention is to provide a pressure regulator comprising a housing having an inlet port and an outlet port, a linearly sliding member for selectively covering a section of a passage between the inlet port and the outlet port, a diaphragm interconnected to the linearly sliding member to slide the linearly sliding member in reaction to pressure levels in the housing, a valve seat located in the passage between the inlet port and the outlet port, wherein the linearly sliding member includes a sealing disc for preventing fluid flow past the valve seat and the valve seat is located closer to the outlet port than to the inlet port, an L-shaped actuating lever interconnecting the diaphragm to the linearly sliding member, a pivot pin pivotally connecting the L-shaped actuating lever to the housing, wherein the pivot pin is located at a bend in the L-shaped actuating lever, the L-shaped actuating lever is configured to rotate about the pivot pin in reaction to pressure levels in the housing, rotation of the L-shaped actuating lever causes lineal movement of the linearly sliding member, the L-shaped actuating lever includes an annual knob on an end thereof, the annular knob being located within an opening in the linearly sliding member, and the knob prevents rotation of the linearly sliding member, and a stem connected to the L-shaped actuating lever and the diaphragm, with the stem rotating the L-shaped actuating lever to thereby slide the linearly sliding member. The housing has an internal chamber, with the inlet port fluidly connected to the internal chamber and the outlet port fluidly connected to the internal chamber. The diaphragm divides the internal chamber into a lower chamber and an upper chamber. The linearly sliding member is located in the internal chamber, with the linearly sliding member having a first position wherein the valve seat is closed by the linearly sliding member, thereby stopping fluid flow between the inlet port and the outlet port. The linearly sliding member having a second position wherein the valve seat is open and not closed by the linearly sliding member, thereby allowing fluid flow between the inlet port and the outlet port.

These and other aspects, objects, and features of the present invention will be understood and appreciated by those skilled in the art upon studying the following specification, claims, and appended drawings.

### BRIEF DESCRIPTION OF THE DRAWINGS

The following brief description of the figures, and the related figures themselves, exemplifies a particular preferred embodiment of the invention constituting the best mode presently contemplated. As will be understood, other embodiments of the invention as well as changes and variations in the particular structure shown in these figures are no doubt possible, and may very well suggest themselves to those skilled in the art after studying this disclosure and these figures.

FIG. 1 is a perspective view of a pressure regulator in accordance with the present invention;

FIG. 2 is a side view of a pressure regulator in accordance with the present invention;

FIG. 3 is a front view of a pressure regulator in accordance with the present invention;

FIG. 4 is a top view of a pressure regulator in accordance with the present invention;

FIG. 5 is a cross-sectional view of the pressure regulator in accordance with the present invention taken along the line B-B of FIG. 2;

FIG. 6 is a cross-sectional view of the pressure regulator in accordance with the present invention taken along the line A-A of FIG. 3;

FIG. 7 is a cross-sectional view of the pressure regulator in accordance with the present invention taken along the line C-C of FIG. 3; and

FIG. 8 is a perspective view of a regulating assembly, an atmospheric screen and a flapper of the pressure regulator in accordance with the present invention.

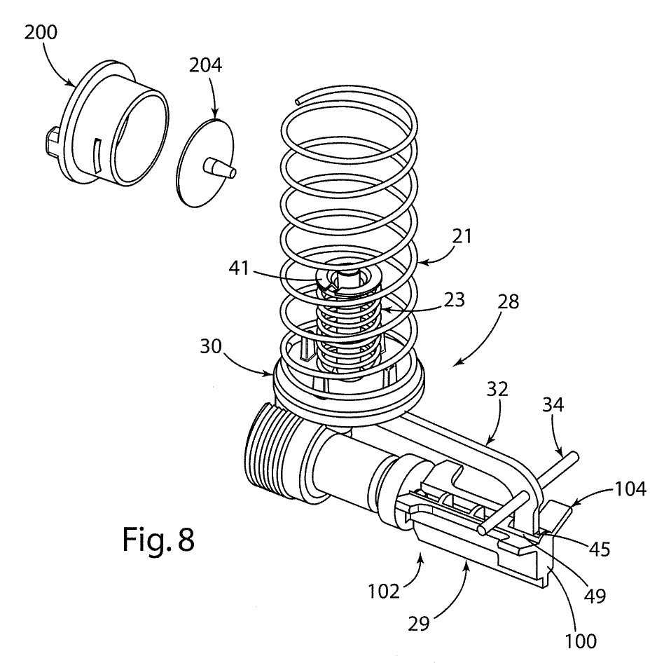

### DETAILED DESCRIPTION OF PREFERRED EMBODIMENT

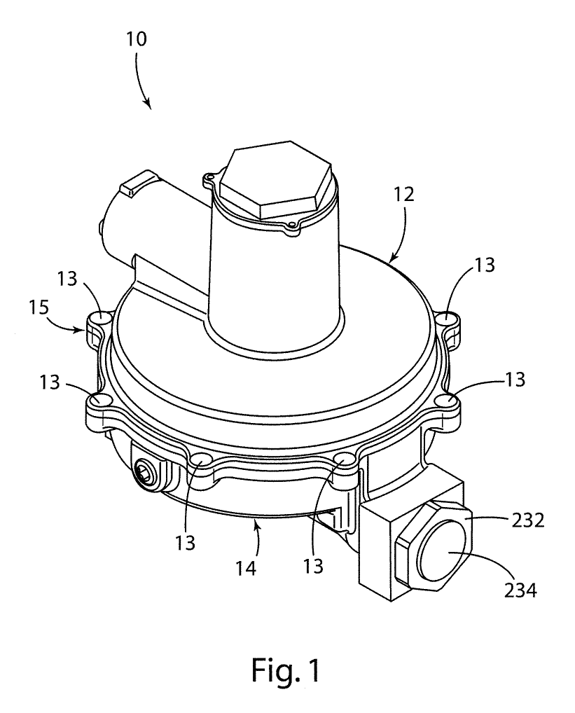

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are simply exemplary embodiments of the inventive concepts. Hence, specific physical details and characteristics present in the embodiments disclosed herein are not to be considered as limiting, unless expressly stated otherwise.

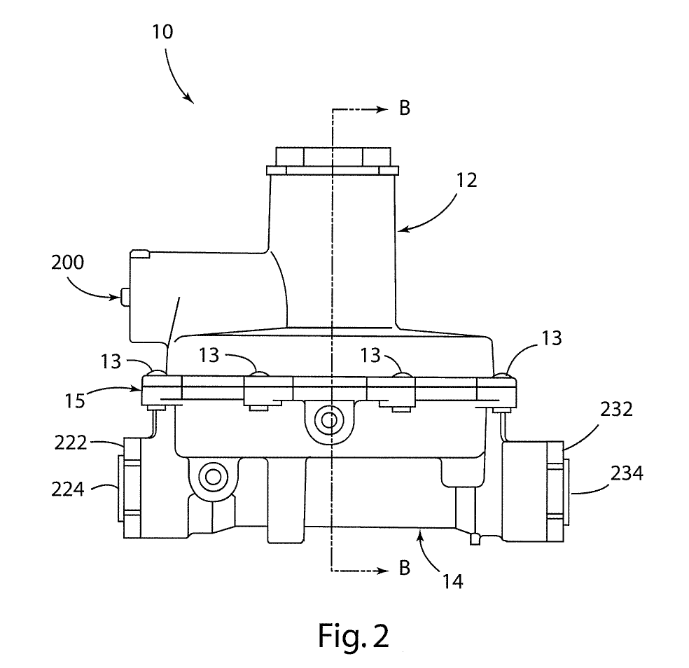

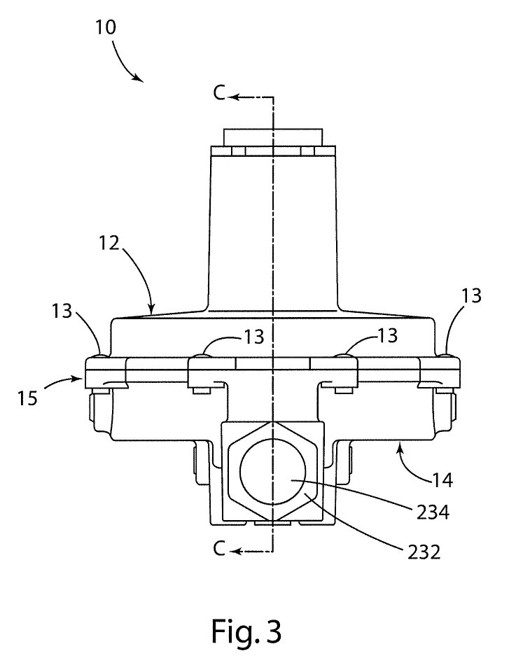

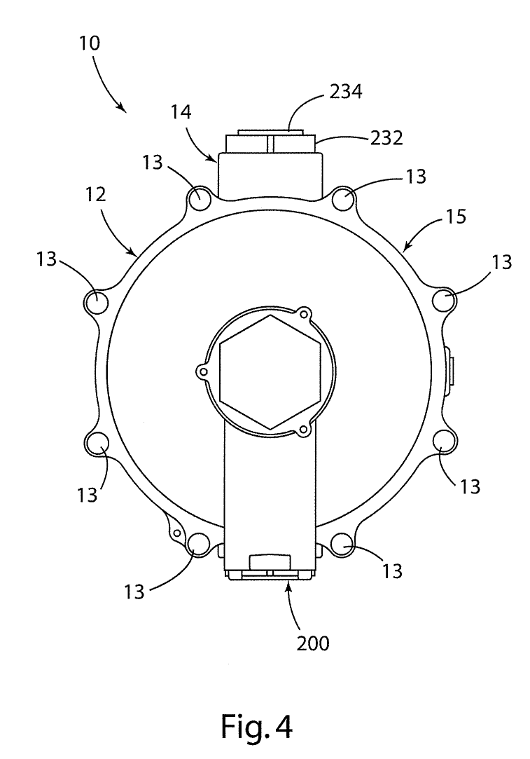

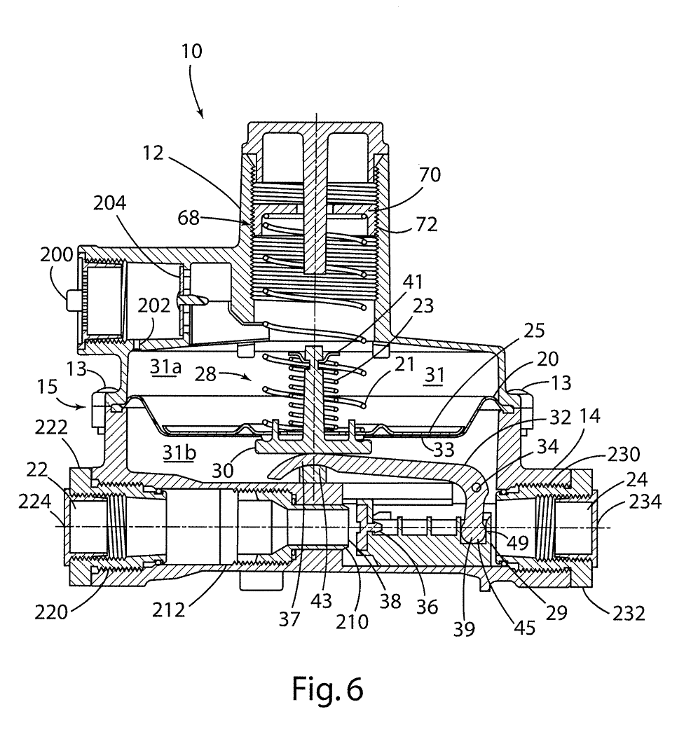

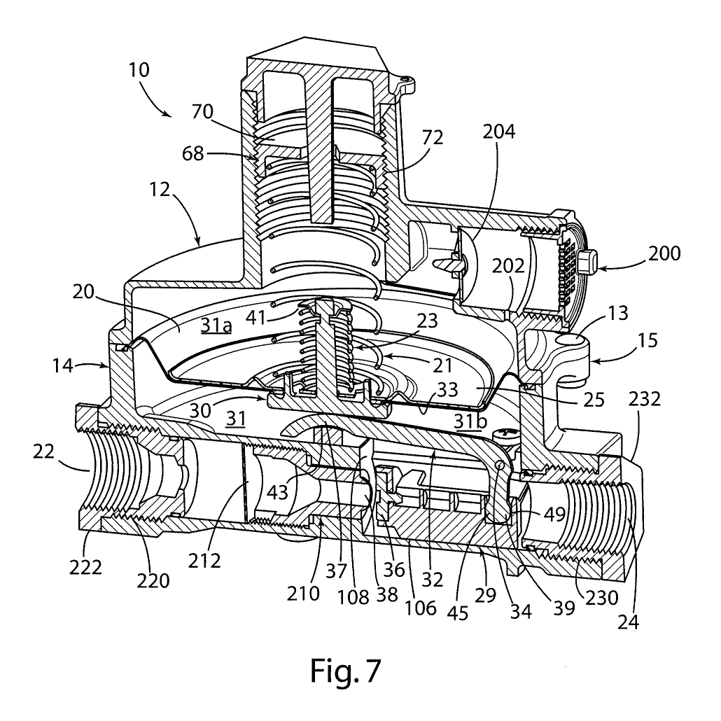

The reference number 10 (FIGS. 1-7) generally designates a pressure regulator embodying the present invention. In the illustrated example, the pressure regulator 10 has an upper body 12 (sometimes called the “bonnet”) and a lower body 14. The upper body 12 and the lower body 14 may be substantially cylindrical. The lower body 14 is connected to the upper body 12 via fasteners 13 (e.g., rivets or screws) extending through mating flanges 15 of the upper body 12 and the lower body 14. It is also contemplated that the upper body 12 and the lower body 14 could be connected by mechanically deforming, or crimping, an upstanding flange on the outside of an upper portion of the lower body 14 over an outer flange of the upper body 12. The crimp could also be reversed with a downward flange on the outside of the lower end of the upper body 12 and an outer flange on the lower body 14. As illustrated in FIGS. 6 and 7, the outer surface of the lower body 14 has an inlet port 22 and an outlet port 24 aligned with the inlet port 22. In use, the inlet port 22 is connected to a source of fuel (e.g., gas (not shown)), and the outlet port 24 is connected to an appliance using fuel (e.g., an outdoor cooking appliance (not shown)).

In the illustrated example, the pressure regulator 10 includes a regulating assembly 28 for controlling the flow of fluid from the inlet port 22 to the outlet port 24. The regulating assembly 28 is located within a regulator cavity 31 defined by the upper body 12 and the lower body 14. The regulating assembly 28 includes an annular diaphragm 20, a post 30, a first spring 21 between the diaphragm 20 and the upper body 12, a second spring 23 between the diaphragm 20 and the post 30, an L-shaped actuating lever 32 and a slider member 29. The diaphragm 20 is clamped between the lower body 14 and the upper body 12 adjacent the mating flanges 15. The diaphragm 20 thereby separates the regulator cavity 31 into an upper regulator cavity area 31a and a lower regulator cavity area 31b. The first spring 21 and the second spring 23 are located in the upper regulator cavity area 31a and the L-shaped actuating lever 32 and the slider member 29 are located in the lower regulator cavity area 31b. The post 30 extends through a center of the diaphragm 20 and therefore is located in both the upper regulator cavity area 31a and the lower regulator cavity area 31b.

The illustrated diaphragm 20 is biased downwardly by the first spring 21, which acts against the top of the diaphragm 20 (via a support plate 25). The diaphragm 20 is connected to the post 30 via the second spring 23, which acts upwardly against a retainer 41 at the top of the post 30. The L-shaped actuating lever 32 is pivotally mounted inside the lower body 14 by a pin 34 extending through a bend in the L-shaped actuating lever 32. A first end 37 of the actuating lever 32 extends through a slot 43 in the post 30 whereby the post 30 can apply movement to the first end 37 of the actuating lever 32. A second end 39 of the L-shaped actuating lever 32 opposite the post 30 and the first end 37 includes an annular knob 45. The annular knob 45 is located with a receiving recess 49 in the slider member 29. The slider member 29 carries a sealing disc 36 which controls the amount of gas allowed to, flow from the inlet port 22 through an orifice 38 in the lower body 14 and out of the outlet port 24 by selectively covering the orifice 38.

The illustrated sliding member 29 carries the sealing disc 36 and prevents or slows fluid flow though the pressure regulator 10. The sliding member 29 includes a body 100 having a front set of wings 102 and a rear set of wings 104. As illustrated, the front set of wings 102 comprise three wings positioned about 120° apart from each other and the rear set of wings 104 comprise three wings positioned about 120° apart from each other. The sliding member 29 is located in a substantially cylindrical chamber 106 in the lower body 14. The substantially cylindrical chamber 106 includes an open top 108. The front set of wings 102 and the rear set of wings 104 allow the sliding member 29 to slide linearly within the cylindrical chamber 106. Furthermore, the annular knob 45 of the actuating lever 32 within the receiving recess 49 prevents the sliding member 29 from rotating within the cylindrical chamber 106 such that the front set of wings 102 and the rear set of wings 104 will not extend through an open top of the cylindrical chamber 106. A front of the body 100 of the sliding member 29 includes an opening for accepting a connection post of the sealing disc 36 to connect the sealing disc 36 to the body 100. It is contemplated that the sealing disc 36 can be mechanically connected to the body 100 using the connection post and/or via an adhesive. In the illustrated example, the sealing disc 36 is closer to the outlet port 24 than to the inlet port 22, thereby allowing better flow stability and decreased flow disturbance through the pressure regulator 10 at greater flow rates when the sealing disc 36 is not covering the orifice 38 as discussed in more detail below.

The illustrated pressure regulator 10 includes an adjustment assembly 68 for selectively adjusting the force applied to the top surface of the diaphragm 20, thereby regulating the amount of pressure needed in the cavity 31 to force the actuating lever 32 to move sliding member 29 and the sealing disc 36 against the orifice 38 to cover the orifice 38. The adjustment assembly 68 includes a spring adjustment guide 70, which is connected to the upper body 12. The illustrated spring adjustment guide 70 moves vertically within the upper body 12 of the pressure regulator 10. The spring adjustment guide 70 abuts against the top of the first spring 21 to compress the first spring 21 and therefore apply a greater force against the top of the diaphragm 20. The spring adjustment guide 70 includes a threaded outer surface 72 that is engaged with a threaded inner surface of the upper member 12 to selectively allow the spring adjustment guide 70 to move towards the diaphragm 20 to compress the first spring 21 or away from the diaphragm to decompress the first spring 21.

In the illustrated example, the fluid in the lower regulator cavity area 31b will apply a pressure to the diaphragm 20 which, when balanced against the spring force applied to the top of the diaphragm 20 by the first spring 21, determines the pressure in the outlet port 24. In a steady state condition, the diaphragm 20 will keep the sealing disc 36 sufficiently away from the orifice 38 to allow fluid to flow at a near constant pressure through the pressure regulator 10. However, if the pressure of the fluid at the outlet port 24 and the regulator cavity 31 rises, the gas in the lower regulator cavity area 31b will press against an underside 33 of the diaphragm 20 to force the diaphragm 20 and the first spring 21 upward. When the diaphragm 20 is forced upwards, the post 30 and first end portion 37 of the actuating lever 32 will move upward, thereby forcing the actuating lever 32 to the move the sliding member 29 to force the sealing disc 36 into contact with the orifice 38, thereby decreasing the flow of fluid to the outlet port 24. When the pressure in the outlet port 24 and the regulator cavity 31 below the diaphragm 20 is reduced, the diaphragm 20 under the force of the first spring 21 above it will move downward, thereby lowering the post 30 and the first end portion 37 of the actuating lever 32, thereby moving the sliding member 29 and the sealing disc 36 away from the orifice 38. Fluid will then again flow through the pressure regulator 10. When the spring adjustment guide 70 is rotated downward, the first spring 21 will be compressed between the spring adjustment guide 70 and the support plate 25. If the first spring 21 is compressed beyond a predetermined point, the spring 21 will force the support plate 25 and the diaphragm 20 to move downward. Therefore, rotating the spring adjustment guide 70 downward will force the first spring 21 and the post 30 downward due to compression of the first spring 21. Consequently, first end portion 37 of the actuating lever 32 will move downward and the sliding member 29 and the sealing disc 36 will move away from the orifice 38, thereby opening the pressure regulator 10. Hence, rotating the spring adjustment guide 70 downward will increase the pressure regulator 10 outlet flow.

Every time the spring adjustment guide 70 moves downward, a new steady-state condition is created for the pressure regulator 10, whereby the sealing disc 36 is located a further distance from the orifice 38, thereby allowing more fluid to pass through the pressure regulator 10. As discussed previously, however, if the pressure of the fluid leaving the outlet port 24 rises above the downward force of the first spring 21 in each such steady state condition, the fluid pressure in the outlet port 24 and in the regulator cavity 31 below the diaphragm 20 will force the diaphragm 20 upwards. When the diaphragm 20 is forced upwards, the second spring 23 will force the post 30 and the first end portion 37 of the actuating lever 32 upwards and force the sealing disc 36 toward the orifice 38, thereby decreasing the flow of fluid into the outlet port 24. When the pressure in the outlet port 24 and the regulator cavity 31 below the diaphragm 20 decreases to a desired level, the first spring 21 will move the diaphragm 20 lower, thereby lowering the post 30 and the first end portion 37 of the actuating lever 32 and moving the sealing disc 36 away from the orifice 38. Fluid flow will then increase through the pressure regulator 10. It is noted that the diaphragm 20 and/or the support plate 25 can be directly connected to the post 30, thereby removing the second spring.

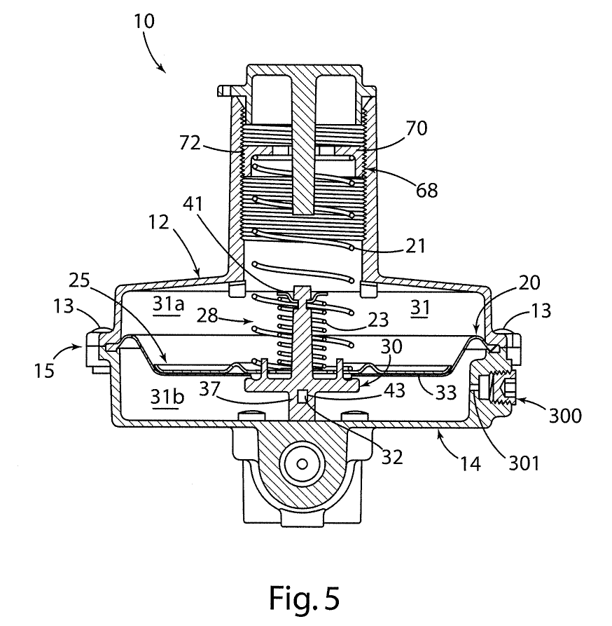

In the illustrated example, the pressure regulator 10 can include several features not discussed above. For example, the upper regulator cavity area 31a is preferably at atmospheric pressure and air can enter the upper regulator cavity area 31a through an atmospheric screen 200 (or plastic vent) and then through a drip hole 202 and into the upper regulator cavity area 31a. A flapper 204 allows the air to exit the upper regulator cavity area 31a and provides flow stability of the air out of the upper regulator cavity area 31a. Furthermore, the orifice 38 is defined by an orifice member 210 located in the lower body 14. The orifice member 210 can include a screen 212 for preventing impurities from entering the appliance. Moreover, the lower body 14 includes an inlet threaded opening 220 adjacent the inlet port 22 for allowing a coupling (not shown) to the screwed into the lower body 14 at the inlet port 22. The lower body 14 can include an inlet adapter 222 threaded into the inlet threaded opening 220 (as shown) to allow a smaller adapter to be connected to the lower body 14. It is noted that FIGS. 1-4 and 6 show a disposable inlet cap 224 screwed into the inlet adapter 222. The disposable inlet cap 224 is configured to be disposed of before use of the pressure regulator 10. Likewise, the lower body 14 includes an outlet threaded opening 230 adjacent the outlet port 24 for allowing a coupling (not shown) to the screwed into the lower body 14 at the outlet port 24. The lower body 14 can include an outlet adapter 232 threaded into the outlet threaded opening 230 (as shown) to allow a smaller adapter to be connected to the lower body 14. It is noted that FIGS. 1-4 and 6 show a disposable outlet cap 234 screwed into the outlet adapter 232. The disposable outlet cap 234 is configured to be disposed of before use of the pressure regulator 10. The pressure regulator 10 can also include a pressure measuring port 301 (see FIG. 5) for allowing pressure measurement of the lower regulator cavity area 31b as required for some applications. A sealing plug 300 closes the measuring port 301 when not in use.

The pressure regulator 10 can also include a pressure relief valve comprising the post 30, the second spring 23 and the retainer 41. The second spring 23 and the retainer 41 compress the plate 25 and the diaphragm 20 onto the post 30 to seal pressure between the upper regulator cavity area 31a and the lower regulator cavity area 31b. When the predetermined pressure in the lower regulator cavity area 31b becomes too great, the second spring 23 moves upward and opens a seal between the diaphragm 20 and the post 30. The flow of gas then passes through the upper regulator cavity area 31a and through screen or vent 200 to the atmosphere. This maintains a safe pressure amount in the lower regulator cavity area 31b and to the downstream appliance.

The pressure regulator of the present invention provides a simplified and very compact design that can be incorporated into various regulator designs with slight modifications and should not be considered only unique to the disclosed design. It should be noted that in the event there is no downstream demand, gas pressure increases inside the chamber until the sealing disc forms a seal on the orifice, causing a zero flow or lockup condition. In this regard, the described invention also includes a safety feature commonly referred to as pressure control. As described previously, the mechanism of this device operates to control output flow pressure to meet downstream demand. When demand increases, outlet pressure decreases and this results in downward movement of the diaphragm and its related parts, including the post, causing the sealing disc to move incrementally away from the orifice and thereby allow more flow through the device to supply the new demand at the same regulated pressure. This continues until the demand is satisfied and an equilibrium state is reached. Conversely, the same events occur in reverse for conditions of decreasing demand. Changes in inlet pressure and/or demand will cause the device to compensate by opening or closing the regulating assembly in response to and in accordance with the new conditions, to again reach an equilibrium state.

The described invention provides consistent repeatable performance over a wide range of inlet pressures and flow rates while also enabling significant reduction in orifice diameter and in diaphragm and overall regulator size. Furthermore, it accomplishes this by use of a simplified mechanism that is less expensive to manufacture and assemble, while at the same time providing better operating results due to the novel design, which substantially reduces function and regulating inaccuracies due to mechanical tolerance variations and lost motion inherent in less directly acting mechanisms which characterize the prior art.

The foregoing detailed description is considered that of a preferred embodiment only, and the particular shape and nature of at least some of the components in this embodiment are at least partially based on manufacturing advantages and considerations as well as on those pertaining to assembly and operation. Modifications of this embodiment may well occur to those skilled in the art and to those who make or use the invention after learning the nature of this preferred embodiment, and the invention lends itself advantageously to such modification and alternative embodiments. Therefore, is to be understood that variations and modifications can be made on the aforementioned structure without departing from the concepts of the present invention, and further it is to be understood that such concepts are intended to be covered by the following claims unless these claims by their language expressly state otherwise.

1. A pressure regulator comprising:
a housing having an inlet port and an outlet port;
a linearly sliding member for selectively covering a section of a passage between the inlet port and the outlet port;
a diaphragm interconnected to the linearly sliding member to slide the linearly sliding member in reaction to pressure levels in the housing; and
a valve seat located in the passage between the inlet port and the outlet port;
wherein the linearly sliding member includes a sealing disc for preventing fluid flow past the valve seat; and
wherein the valve seat is located closer to the outlet port than to the inlet port.

2. The pressure regulator of claim 1, wherein:
an L-shaped actuating lever interconnects the diaphragm to the linearly sliding member;
a pivot pin pivotally connects the L-shaped actuating lever to the housing;
the pivot pin is located at a bend in the L-shaped actuating lever;
the L-shaped actuating lever is configured to rotate about the pivot pin in reaction to pressure levels in the housing; and
rotation of the L-shaped actuating lever causes linear movement of the linearly sliding member.

3. The pressure regulator of claim 2, wherein:
the L-shaped actuating lever includes an annular knob on an end thereof, the annular knob being located within an opening in the linearly sliding member; and
the knob preventing rotation of the linearly sliding member.

4. The pressure regulator of claim 3, wherein:
the linearly sliding member is located in a substantially cylindrical chamber.

5. The pressure regulator of claim 2, further including:
a stem connected to the L-shaped actuating lever and the diaphragm, the stem rotating the L-shaped actuating lever to thereby slide the linearly sliding member.

6. The pressure regulator of claim 1, wherein:
the housing has an internal chamber, with the inlet port fluidly connected to the internal chamber and the outlet port fluidly connected to the internal chamber;
the diaphragm divides the internal chamber into a lower chamber and an upper chamber; and
the linearly sliding member is located in the internal chamber, the linearly sliding member having a first position wherein the valve seat is closed by the linearly sliding member, thereby stopping fluid flow between the inlet port and the outlet port, the linearly sliding member having a second position wherein the valve seat is open and not closed by the linearly sliding member, thereby allowing fluid flow between the inlet port and the outlet port.

7. The pressure regulator of claim 1, further including:
a rotatable adjustment cap connected to the housing;
a biasing element applying a force to the diaphragm to bias the linearly sliding member such that the valve seat is not closed;
wherein rotation of the rotatable adjustment cap alternatively compresses the biasing element to increase the force applied to the diaphragm and decompresses the biasing element to decrease the force applied to the diaphragm.

8. The pressure regulator of claim 1, wherein:
the linearly sliding member is located in a substantially cylindrical chamber; and
the linearly sliding member includes a central portion and wings extending outwardly from the central portion;
the wings maintain the linearly sliding member in position within the substantially cylindrical chamber.

9. The pressure regulator of claim 8, wherein:
the wings comprise front wings and rear wings.

10. The pressure regulator of claim 9, wherein:
the front wings include three wings each separated by 120°; and
the rear wings include three wings each separated by 120°.

11. The pressure regulator of claim 8, wherein:
the wings include three wings.

12. The pressure regulator of claim 11, wherein:
the wings are each separated by 120°.

13. A method of assembling a pressure regulator comprising:
providing a housing having an inlet port and an outlet port;
positioning a linearly sliding member in the housing for selectively covering a section of a passage between the inlet port and the outlet port;
interconnecting a diaphragm to the linearly sliding member to slide the linearly sliding member in reaction to pressure levels in the housing;
locating a valve seat in the passage between the inlet port and the outlet port;
providing the linearly sliding member with a sealing disc for preventing fluid flow past the valve seat; and
locating the valve seat closer to the outlet port than to the inlet port.

14. The method of assembling the pressure regulator of claim 13, wherein:
an L-shaped actuating lever interconnects the diaphragm to the linearly sliding member;
a pivot pin pivotally connects the L-shaped actuating lever to the housing;
the pivot pin is located at a bend in the L-shaped actuating lever;
the L-shaped actuating lever is configured to rotate about the pivot pin in reaction to pressure levels in the housing; and
rotation of the L-shaped actuating lever causes linear movement of the linearly sliding member.

15. The method of assembling the pressure regulator of claim 14, wherein:
the L-shaped actuating lever includes an annual annular knob on an end thereof, the annular knob being located within an opening in the linearly sliding member; and
the knob preventing rotation of the linearly sliding member.

16. The method of assembling the pressure regulator of claim 15, wherein:
the linearly sliding member is located in a substantially cylindrical chamber.

17. The method of assembling the pressure regulator of claim 14, wherein:
a stem is connected to the L-shaped actuating lever and the diaphragm, the stem rotating the L-shaped actuating lever to thereby slide the linearly sliding member.

18. The method of assembling the pressure regulator of claim 13, wherein:
the housing has an internal chamber, with the inlet port fluidly connected to the internal chamber and the outlet port fluidly connected to the internal chamber;
the diaphragm divides the internal chamber into a lower chamber and an upper. chamber; and
the linearly sliding member is located in the internal chamber, the linearly sliding member having a first position wherein the valve seat is closed by the linearly sliding member, thereby stopping fluid flow between the inlet port and the outlet port, the linearly sliding member having a second position wherein the valve seat is open and not closed by the linearly sliding member, thereby allowing fluid flow between the inlet port and the outlet port.

19. The method of assembling the pressure regulator of claim 13, wherein:
the linearly sliding member is located in a substantially cylindrical chamber; and
the linearly sliding member includes a central portion and wings extending outwardly from the central portion;
the wings maintain the linearly sliding member in position within the substantially cylindrical chamber.

20. A pressure regulator comprising:
a housing having an inlet port and an outlet port;
a linearly sliding member for selectively covering a section of a passage between the inlet port and the outlet port;
a diaphragm interconnected to the linearly sliding member to slide the linearly sliding member in reaction to pressure levels in the housing;
a valve seat located in the passage between the inlet port and the outlet port;
wherein the linearly sliding member includes a sealing disc for preventing fluid flow past the valve seat;
wherein the valve seat is located closer to the outlet port than to the inlet port;
an L-shaped actuating lever interconnecting the diaphragm to the linearly sliding member;
a pivot pin pivotally connecting the L-shaped actuating lever to the housing;
wherein the pivot pin is located at a bend in the L-shaped actuating lever;
wherein the L-shaped actuating lever is configured to rotate about the pivot pin in reaction to pressure levels in the housing; and
wherein rotation of the L-shaped actuating lever causes linear movement of the linearly sliding member;
wherein the L-shaped actuating lever includes an annular knob on an end thereof, the annular knob being located within an opening in the linearly sliding member;
wherein the knob prevents rotation of the linearly sliding member; and
a stem connected to the L-shaped actuating lever and the diaphragm, the stem rotating the L-shaped actuating lever to thereby slide the linearly sliding member;
wherein the housing has an internal chamber, with the inlet port fluidly connected to the internal chamber and the outlet port fluidly connected to the internal chamber;
wherein the diaphragm divides the internal chamber into a lower chamber and an upper chamber; and
wherein the linearly sliding member is located in the internal chamber, the linearly sliding member having a first position wherein the valve seat is closed by the linearly sliding member, thereby stopping fluid flow between the inlet port and the outlet port, the linearly sliding member having a second position wherein the valve seat is open and not closed by the linearly sliding member, thereby allowing fluid flow between the inlet port and the outlet port.
